(19) United States
(12) Patent Application Publication
(10) Pub. No.: US 2026/0154639 A1
(43) Pub. Date: Jun. 4, 2026

(54) SYSTEMS AND METHODS FOR DEVELOPING AND ORCHESTRATING AUTOMATION WORKFLOWS

(71) Applicant: KORE.AI, INC., Orlando, FL (US)

(72) Inventors: Rajkumar Koneru, Windemere, FL (US); Prasanna Kumar Arikala Gunalan, Hyderabad (IN); Jayesh Arunkumar Jain, Bhusawal (IN)

(21) Appl. No.: 19/393,416

(22) Filed: Nov. 18, 2025

Related U.S. Application Data
(60) Provisional application No. 63/727,552, filed on Dec. 3, 2024.

(51) Int. Cl. G06Q 10/0631

(52) U.S. Cl. CPC G06Q 10/06316

(57) ABSTRACT

An automation server receives one or more user inputs from one of a plurality of user devices associated with a user during an online dialog session between the user and an automation agent. The automation server determines a plurality of tasks to be executed based on the one or more user inputs. At least one of the plurality of tasks is executed using a deterministic workflow and at least another one of the plurality of tasks is executed using a dynamic workflow. Subsequently, one or more responses to the one of the plurality of user devices are provided based on the execution.

This application claims priority to U.S. Provisional Patent Application Ser. No. 63/727,552, filed Dec. 3, 2024, which is hereby incorporated herein by reference in its entirety.

### FIELD

This technology generally relates to the field of automation, and more particularly to methods, systems, and computer-readable media for developing and orchestrating automation workflows.

### BACKGROUND

Conversational artificial intelligence (conversational AI) systems have evolved over the years from hard-coded question answering systems to advanced, dynamic models capable of understanding and generating natural language. Initially, these systems were rule-based, relying on pre-programmed responses to specific queries. However, with the advent of machine learning, particularly deep learning and neural networks, conversational AI has become more sophisticated and enabling context-aware interactions. Today, these systems leverage large language models to generate human-like responses and support multi-turn dialogues.

Enterprises are adopting conversational AI systems powered by large language models (LLMs) for a range of applications, including text summarization, rephrasing, language translation, or the like. However, despite the advantages, challenges persist. Ensuring that LLM-based conversational AI systems provide accurate and reliable outputs, especially in complex use cases requires building elaborate workflows, rules, ongoing monitoring, and fine-tuning. Also, seamless integration with existing enterprise infrastructures can be resource intensive. As a result, there is a need to improve conversational AI systems.

### SUMMARY

In one example, the present disclosure relates to a method for receiving, by an automation server, one or more user inputs from one of a plurality of user devices associated with a user during an online dialog session between the user and an automation agent. Subsequently, a plurality of tasks to be executed based on the one or more user inputs are determined. At least one of the plurality of tasks is executed using a deterministic workflow and at least another one of the plurality of tasks is executed using a dynamic workflow. Further, one or more responses to the one of the plurality of user devices are provided based on the execution.

In another example, the present disclosure relates to an automation server comprising one or more processors and a memory coupled to the one or more processors which are configured to execute programmed instructions stored in the memory to receive one or more user inputs from one of a plurality of user devices associated with a user during an online dialog session between the user and an automation agent. Subsequently, a plurality of tasks to be executed based on the one or more user inputs are determined. At least one of the plurality of tasks is executed using a deterministic workflow and at least another one of the plurality of tasks is executed using a dynamic workflow. Further, one or more responses to the one of the plurality of user devices are provided based on the execution.

In another example, the present disclosure relates to a non-transitory computer readable storage medium storing instructions which when executed by one or more processors, causes the one or more processors to receive one or more user inputs from one of a plurality of user devices associated with a user during an online dialog session between the user and an automation agent. Subsequently, a plurality of tasks to be executed based on the one or more user inputs are determined. At least one of the plurality of tasks is executed using a deterministic workflow and at least another one of the plurality of tasks is executed using a dynamic workflow. Further, one or more responses to the one of the plurality of user devices are provided based on the execution.

### BRIEF DESCRIPTION OF THE DRAWINGS

FIG. 1 is a block diagram of an exemplary computing environment for implementing the concepts and technologies disclosed herein.

FIG. 2A is a block diagram of an exemplary architecture of the components of an automation platform of an automation server.

FIG. 2B is a block diagram of an exemplary agent platform of the automation server.

FIG. 2C is a block diagram of an exemplary automation agent configured using the automation platform.

FIG. 2D is a block diagram of an exemplary dynamic workflow of the automation agent.

FIG. 2E is an exemplary wireframe of the dynamic workflow rendered in an agent builder graphical user interface provided by the automation server.

FIG. 2F is an exemplary wireframe of a deterministic workflow rendered in the agent builder graphical user interface provided by the automation server.

FIG. 3 is a flowchart of an exemplary method for orchestrating an online interaction with a user at one of a plurality of user devices.

FIG. 4 is a functional block diagram of an exemplary automation agent configured using the automation platform.

FIG. 5 is a diagram of an exemplary interaction flow between different components of the exemplary computing environment of FIG. 1.

### DETAILED DESCRIPTION

Examples of the present disclosure relate to a computing environment and, more particularly, to one or more components, systems, computer-readable media, and methods of the computing environment using artificial intelligence agents. The computing environment is configured to enable communication between users and automation agents hosted and/or managed by the computing server.

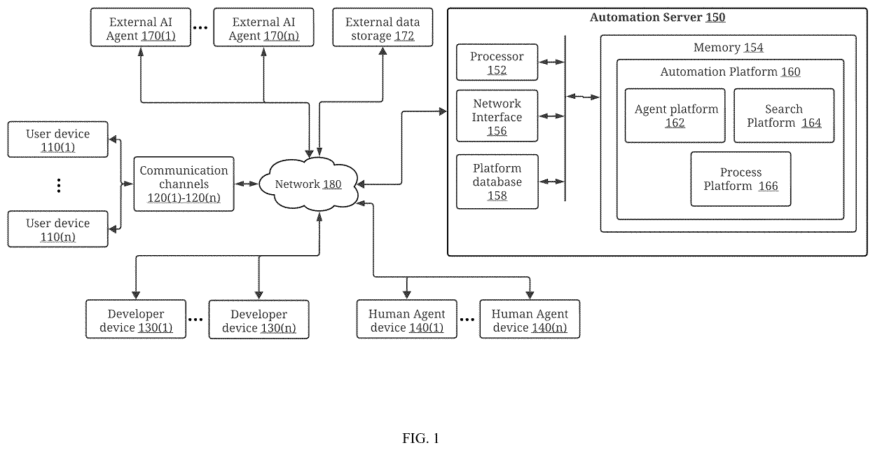

FIG. 1 is a block diagram of an exemplary computing environment 100 for implementing the concepts and technologies disclosed herein. The computing environment 100 includes: a plurality of user devices 110(1)-110(n), a plurality of communication channels 120(1)-120(n), a plurality of developer devices 130(1)-130(n), a plurality of human agent devices 140(1)-140(n), an automation server 150, a plurality of external artificial intelligence agents 170(1)-170(n) (hereinafter referred to as the plurality of external AI agents 170(1)-170(n)), and external data storage 172, coupled together via a network 180, although the computing environment 100 can include other types and/or numbers of systems, devices, components, and/or elements in other examples. Although not shown, the exemplary computing environment 100 may include additional network components, such as gateways, routers, switches and other devices, which are well known to those of ordinary skill in the art and thus will not be described here.

Referring to FIG. 1, the user devices 110(1)-110(n) may include, but are not limited to, smartphones, tablets, laptops, desktop computers, or any computing device capable of network communication. Each of the user devices 110(1)-110(n) may be configured to communicate with the automation server 150 via one or more web applications or one or more of the communication channels 120(1)-120(n), although other types and/or numbers of application or channels may be used in other examples. The user devices 110(1)-110(n) may each include a processor and a memory configured to execute client-side applications and manage user interactions. The user devices 110(1)-110(n) may further each include one or more input devices such as a keyboard, a mouse, a display device or a touch interface as well as one or more output or display devices for presenting graphical or textual information. Additionally, the user devices 110(1)-110(n) may each include one or more communication interfaces for transmitting and receiving data with the automation server 150 over the network 180. The user devices 110(1)-110(n) may each comprise other types and/or numbers of other systems, devices, components in other examples. The users accessing the user devices 110(1)-110(n) provide user inputs to the automation server 150 and receive responses from the automation server 150.

The communication channels 120(1)-120(n) refer to the various interfaces or platforms through which the user devices 110(1)-110(n) exchange information with the automation server 150. The communication channels 120(1)-120(n) may include, for example, enterprise messaging platforms, artificial intelligence agent (AI agent) interfaces, social messaging platforms, web and mobile applications, interactive voice response (IVR) channels, voice channels, live chat channels, webhook channels, short messaging service (SMS), email, software-as-a-service (SaaS) applications, voice over internet protocol (VOIP) calls, computer telephony calls, although the communication channels 120(1)-120(n) may include other types and/or numbers of interfaces or platforms in other examples.

The developer devices 130(1)-130(n) may include, but are not limited to, smartphones, tablets, laptops, desktop computers, or any computing device capable of network communication. Each of the developer devices 130(1)-130(n) may be configured to communicate with the automation server 150 via one or more web applications or one or more of the communication channels 120(1)-120(n), although other types and/or numbers of application or channels may be used in other examples. The developer devices 130(1)-130(n) may each include a processor and a memory configured to execute client-side applications and manage developer interactions. The developer devices 130(1)-130(n) may each further include one or more input devices such as a keyboard, a mouse, a display device or a touch interface as well as one or more output or display devices for presenting graphical or textual information. Additionally, the developer devices 130(1)-130(n) may each include one or more communication interfaces for transmitting and receiving data with the automation server 150 over the network 180. The developer devices 130(1)-130(n) may each comprise other types and/or numbers of other systems, devices, components in other examples. Enterprise users, such as developers, accessing the developer devices 130(1)-130(n) provide inputs to the automation server 150 and receive responses from the automation server 150.

The human agent devices 140(1)-140(n) may be, for example, a desktop computer, a laptop computer, a tablet computer, a smartphone, a mobile phone, or any other type of device with communication and data exchange capabilities. The human agent devices 140(1)-140(n) may be devices associated with a contact center and the human agents at the human agent devices 140(1)-140(n) may communicate with the user at one or more of the user devices 110(1)-110(n) over the network 180. Also, the human agent devices 140(1)-140(n) comprise an agent device graphical user interface (GUI) (not shown) that may render and display data received from the automation server 150 or the user devices 110(1)-110(n). The human agent devices 140(1)-140(n) may run applications such as web browsers or a contact center software, which may render the agent device GUI, although other applications may render the agent device GUI.

The automation server 150 is any type of server or other network-connected computing resource that helps automate various software development processes such as, for example, building, testing, and deploying software applications. The automation server 150 includes a processor 152, a memory 154, a network interface 156, and a platform database 158 although the automation server 150 may include other types and/or numbers of components in other examples. Although one processor 152, one memory 154, and one network interface 156 are illustrated, it may be understood that, in other examples, there may be a plurality of: processor 152, memory 154, network interface 156, or platform database 158 components in other examples. In addition, the automation server 150 may include an operating system (not shown). While the automation server 150 is illustrated as a single server, the automation server 150 can include one or more servers, and various components of automation server 150 can be locally integrated within the one or more servers or may be distributed in nature. In some examples, the automation server 150 may also be deployed as one or more virtual servers within a cloud computing environment, where its components are provisioned, scaled, and managed dynamically across cloud infrastructure. In yet other examples, the automation server 150 may operate in a hybrid deployment, with certain components hosted on cloud infrastructure and others maintained on-premise.

The components of the automation server 150 may be coupled by one or more communication buses such as, for example, a graphics bus, a memory bus, an Industry Standard Architecture (ISA) bus, an Extended Industry Standard Architecture (EISA) bus, a Micro Channel Architecture (MCA) bus, a Video Electronics Standards Association (VESA) Local bus, a Peripheral Component Interconnect (PCI) bus, a PCI-Express (PCIe) bus, a serial advanced technology attachment (SATA) bus, a Personal Computer Memory Card Industry Association (PCMCIA) bus, an Small Computer Systems Interface (SCSI) bus, or a combination of two or more of these, although the components of the automation server 150 may be coupled using other types and/or numbers of buses or systems in other examples. In one example, the components of the automation server 150 may be communicatively coupled with each other.

The automation server 150 receives communication from the user devices 110(1)-110(n) or the developer devices 130(1)-130(n), processes them, and orchestrates various automation tasks. In one example, the processes performed by the automation server 150 may be implemented using a networking environment (e.g., cloud computing environment) or offered as a service through the cloud computing environment. The automation server 150 may use automation, artificial intelligence, human agents, or a combination of these to respond to the incoming communication. Additionally, the automation server 150 also communicates with the external AI agents 170(1)-170(n) or external data storage 172, although the automation server 150 may communicate with other components not illustrated in the computing environment 100.

The processor 152 of the automation server 150 may include a Central Processing Unit (CPU), a Graphics Processing Unit (GPU), a Digital Signal Processor (DSP), a Programmable Logic Device (PLD), a Reduced Instruction Set Computing (RISC) processor, an Application-Specific Integrated Circuit (ASIC) processor, a Complex Instruction Set Computing (CISC) processor, a microcontroller, or other similar circuitry capable of performing one or more operations on data. The processor 152 may be configured to execute one or more instructions that may, for example, be stored in the memory 154. The processor 152, although illustrated as a single unit, may include multiple processors or processing cores operating in parallel. In some examples, the processors may be distributed across different physical or virtual machines.

The memory 154 of the automation server 150 is an example of a non-transitory computer readable storage medium configured to store information or one or more instructions for the processor 152 to execute. The instructions, which when executed by the processor 152, perform one or more processes such as one or more of the disclosed examples. The memory 154 may include software modules that, upon execution by the processor 152, implement one or more functions as described in the examples below. The memory 154 may include one or more non-transitory computer readable media that may be accessed by the processor 152. For example, the memory 154 may be a random access memory (RAM), a dynamic random access memory (DRAM), a static random access memory (SRAM), a persistent memory (PMEM), a nonvolatile dual in-line memory module (NVDIMM), a hard disk drive (HDD), a read only memory (ROM), an erasable programmable read-only memory (EPROM), an electrically erasable programmable read-only memory (EEPROM), a programmable ROM (PROM), a flash memory, a compact disc (CD), a digital video disc (DVD), a magnetic disk, a universal serial bus (USB) memory card, a memory stick, or a combination of two or more of these. It may be understood that the memory 154 may include other electronic, magnetic, optical, electromagnetic, infrared or semiconductor based non-transitory computer readable storage medium which may be used to tangibly store instructions. The non-transitory computer readable medium is not a transitory signal per se and is any tangible medium that contains and stores the instructions for use by or in connection with an instruction execution system, apparatus, or device. Examples of the programmed instructions and steps stored in the memory 154 are illustrated and described by way of the description and examples herein.

As illustrated in FIG. 1, the memory 154 may include programmed instructions, data structures, or other data corresponding to an agent platform 162, a search platform 164, and a process platform 166, although other types and/or numbers of instructions in the form of programs, functions, methods, procedures, definitions, subroutines, or modules may be stored in other examples. One or more components of the memory 154 may be communicatively coupled with each other.

The network interface 156 is configured to enable communication between the automation server 150 and one or more external components over the network 180. The network interface 156 may include hardware components, software modules, or a combination thereof for implementing one or more communication protocols, such as wired, wireless, or optical networking protocols. The network interface 156 may comprise one or more of: a network adapter, a telephone interface, a modem, a transceiver, a router, a gateway, virtualized network components, or a virtualized communication interface, although the network interface 156 may comprise other types and/or numbers of components in other examples. In some examples, the network interface 156 facilitates bidirectional data exchange with the user devices 110(1)-110(n), the developer devices 130(1)-130(n), the external AI agents 170(1)-170(n), or the external storage 172. The network interface 156 may further support secure communication using encryption or authentication mechanisms to preserve data integrity and confidentiality. In this manner, the network interface 156 provides the communication layer through which the automation server 150 exchanges information with distributed components of the computing environment 100 to manage and orchestrate communication across heterogeneous devices and systems.

The platform database 158 of the automation server 150 is an example of a non-transitory computer-readable storage medium configured to persistently store data, models, code, configuration, and application resources utilized by the automation platform 160. In some examples, the platform database 158 may store enterprise data, knowledge bases, user profiles, conversation histories, intent definitions, fulfillment rules, embeddings, and other information required for processing user inputs or developer inputs and generating responses, although the platform database 158 may store or process other types and/or numbers of data in other examples. The platform database 158 may further store logs, metrics, and monitoring data to enable auditing, optimization, and continuous improvement of automation workflows.

The platform database 158 may be implemented using one or more database technologies, depending on system requirements and performance considerations. For example, the platform database 158 may be implemented as a vector database that stores high-dimensional vector embeddings representing user inputs, enterprise documents, or contextual knowledge, enabling similarity search and retrieval-augmented generation (RAG). In another example, the platform database 158 may be implemented as a relational database (e.g., SQL-based) which organizes structured information, such as user accounts, authentication credentials, or transaction records. NoSQL databases, such as key-value stores, document databases, or graph databases, may be utilized to handle semi-structured and unstructured data, including FAQs, dialogue states, hierarchical intent mappings, and agent knowledge graphs.

In some examples, the platform database 158 may be realized as a hybrid storage architecture in which multiple database types are integrated. For example, structured enterprise records may be maintained in relational tables, conversation histories may be preserved in a document database, and embeddings may be indexed in a vector database optimized for high-dimensional similarity search. In distributed deployments, the platform database 158 may be implemented across on-premises servers, cloud-based storage services, or federated databases, with synchronization mechanisms to ensure data consistency and availability across environments, although other types and/or numbers of deployment configurations may be used in other examples.

The external AI agents 170(1)-170(n) represent artificial intelligence agents configured to communicate with the automation server 150 over the network 180. Each of the external AI agents 170(1)-170(n) may be hosted on external servers, third-party platforms, cloud-based services, or other computing devices and may provide specialized intelligence or task automation capabilities that communicate with the automation platform 160 or extend the functionality of the automation platform 160. The external AI agents 170(1)-170(n) may be built on, for example, large language models (LLMs), small language models (SLMs), multimodal models, or domain-specific expert models that can process, generate, and exchange data with the automation server 150, although the external AI agents 170(1)-170(n) may be built on other types and/or numbers of language models in other examples.

The automation server 150 may initiate communication with external AI agents 170(1)-170(n) through secure APIs, webhooks, or message queues to delegate or coordinate tasks, such as retrieval-augmented generation, semantic search, reasoning, summarization, data enrichment, or tool execution, although the automation server 150 may communicate with the external AI agents 170(1)-170(n) for other types and/or numbers of tasks. The external AI agents 170(1)-170(n) may respond with computed results, model inferences, or structured responses that are integrated into the conversation or automation workflow orchestrated by the automation server 150. In other examples, the external AI agents 170(1)-170(n) may initiate communication with the automation server 150.

The automation server 150 may dynamically select, prompt, or chain the external AI agents 170(1)-170(n) based on context, intent, model capabilities, confidence scores, response latency, domain relevance, orchestration rules, or workload distribution, although the communication may be based on other types and/or numbers of factors in other examples. Further, the external AI agents 170(1)-170(n) may interact with external data storage 172, enterprise knowledge graphs, or external APIs to retrieve or process information required for fulfilling a user intent or a system intent. In some examples, the external AI agents 170(1)-170(n) may be orchestrated in a cooperative or hierarchical manner, wherein one or more agents act as supervisor agents responsible for planning or coordination, while other agents act as worker agents performing specialized subtasks.

The external data storage 172 may comprise one or more external databases, knowledge bases, or data repositories that are accessible to the automation server 150 and/or the external AI agents 170(1)-170(n). The external data storage 172 may include enterprise data lakes, vector databases, cloud storage systems, or third-party content repositories containing structured, semi-structured, or unstructured data, although the external data storage 172 may include other types and/or numbers of databases or data formats in other examples. The external data storage 172 may be used to persist embeddings, documents, historical logs, or contextual datasets that support retrieval-augmented generation (RAG), analytics, or compliance functions, although other types and/or numbers of data or operations may be stored or supported in other examples.

The network 180 enables the user devices 110(1)-110(n), the developer devices 130(1)-130(n), the human agent devices 140(1)-140(n), the external AI agents 170(1)-170(n), and the external data storage 172, or other components of the computing environment 100 to communicate with the automation server 150. The network 180 may be, for example, an ad hoc network, an extranet, an intranet, a wide area network (WAN), a virtual private network (VPN), a local area network (LAN), a wireless LAN (WLAN), a wireless WAN (WWAN), a metropolitan area network (MAN), internet, a portion of the internet, a portion of the public switched telephone network (PSTN), a cellular telephone network, a wireless network, a Wi-Fi network, or a combination of two or more such networks, although the network 180 may include other types and/or numbers of networks in other topologies or configurations.

The network 180 may support protocols such as, Session Initiation Protocol (SIP), Hypertext Transfer Protocol (HTTP), Hypertext Transfer Protocol Secure (HTTPS), Media Resource Control Protocol (MRCP), Real Time Transport Protocol (RTP), Real-Time Streaming Protocol (RTSP), Real-Time Transport Control Protocol (RTCP), Session Description Protocol (SDP), Web Real-Time Communication (WebRTC), Transmission Control Protocol/Internet Protocol (TCP/IP), User Datagram Protocol (UDP), or Voice over Internet Protocol (VoIP), although other types and/or numbers of protocols may be supported in other topologies or configurations. The network 180 may also support standards or formats such as, for example, hypertext markup language (HTML), extensible markup language (XML), voiceXML, call control extensible markup language (CCXML), JavaScript object notation (JSON), although other types and/or numbers of data, media, and document standards and formats may be supported in other topologies or configurations. The automation server 150 may include any interface that is suitable to connect with any of the above-mentioned network types and communicate using any of the above-mentioned network protocols, standards, or formats.

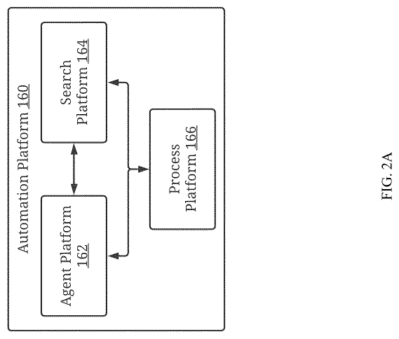

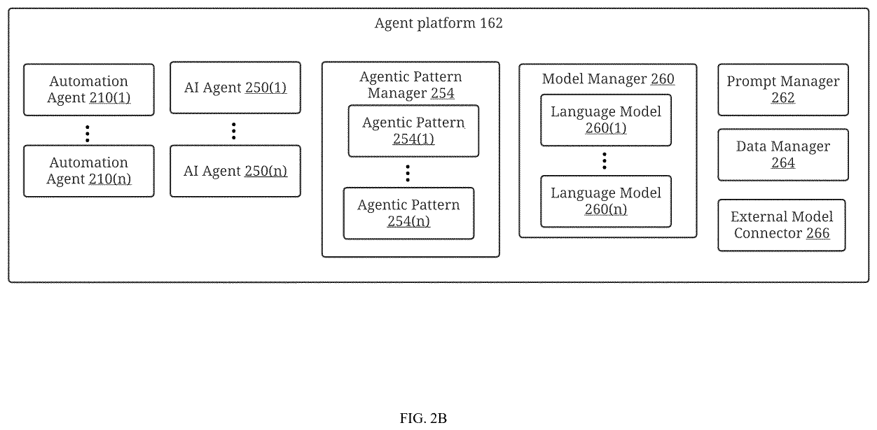

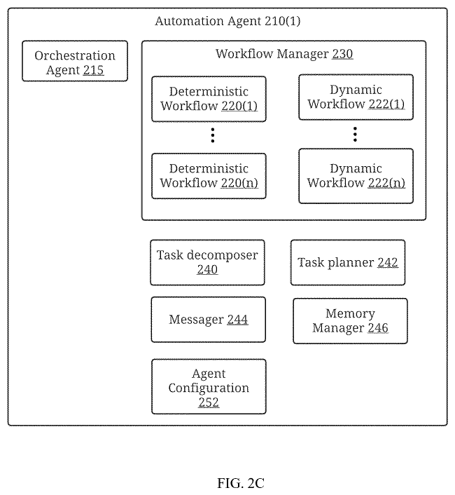

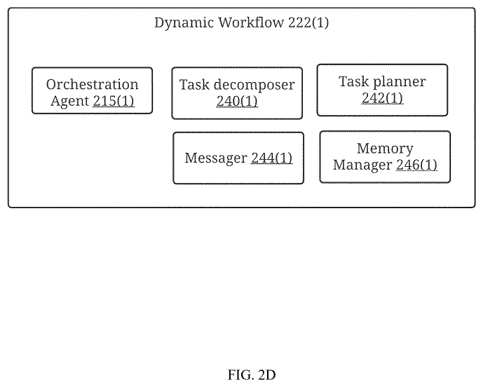

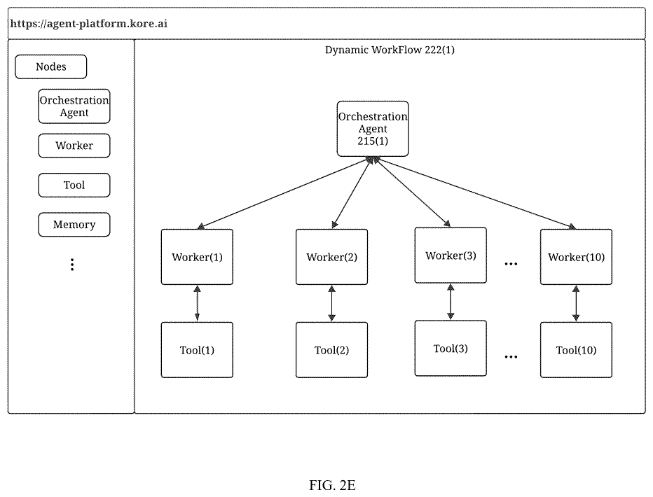

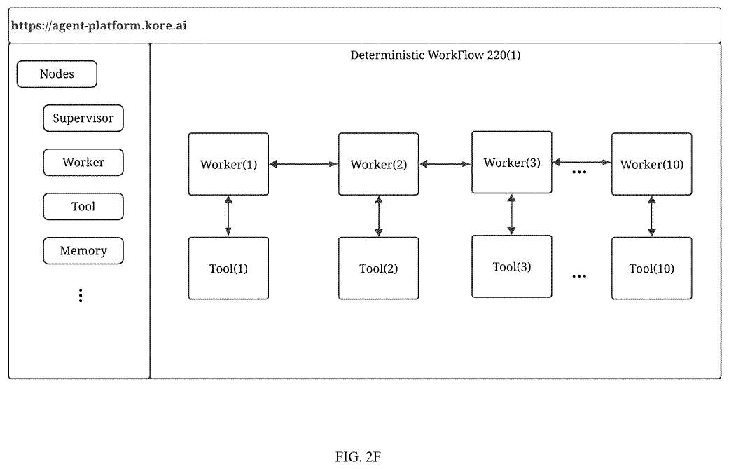

FIG. 2A is a block diagram of an exemplary architecture of the components of the automation platform 160 of the automation server 150. The automation platform 160 comprises executable code and configuration data configured to operate the agent platform 162, the search platform 164, and the process platform 166, although the automation platform 160 may comprise other types and/or numbers of components in other examples. In one example, other configuration or data corresponding to the agent platform 162, the search platform 164, and the process platform 166 may be stored within the platform database 158. The automation platform 160 enables developers to build one or more applications by creating one or more workflows using low-code or no-code techniques. The applications, such as automation agents, are software programs capable of interacting with its environment, gather data, and use the gathered data to carry out tasks autonomously in pursuit of objectives predefined by developers at the developer devices 130(1)-130(n). The automation platform 160 may comprise or provide one or more software tools configured to instantiate an integrated development environment (IDE), said IDE being accessible to the developer devices 130(1)-130(n). In one example, the automation platform 160 is further configured to provide this IDE as a unified web-based interface. This interface may further comprise sub-tools or modules associated with the agent platform 162, the search platform 164, and the process platform 166. In another example, each of these platforms may be provided as separate, standalone tools. Agentic applications or other applications created using the automation platform 160 may integrate functionalities of the agent platform 162, the search platform 164, and the process platform 166 to perform complex, context-aware automation tasks. In such implementations, communication and data exchange between these components may be enabled through standardized inter-platform protocols, shared data schemas, or message-passing interfaces to ensure synchronized operation, consistent data flow, and coordinated decision-making across the platforms.

The automation platform 160 may further provide no-code and pro-code development capabilities, including graphical builders, software development kits (SDKs), pro-code extensions, templates, and Model Context Protocol (MCP) integrations. In some examples, an enterprise user such as the developer operating the developer device 130(1) may access the automation platform 160 by visiting a website hosted by the automation server 150 through a browser, wherein data packets transmitted between the browser and the automation server 150 render graphical user interfaces for interacting with various tools of the automation platform 160. In other examples, the automation platform 160 may be accessible as a local application installed on the developer devices 130(1)-130(n). Subsequent to development, an automation agent configured using the automation platform 160 may be deployed and may be accessible on the user devices 110(1)-110(n).

The agent platform 162 provides an environment for creating, configuring, deploying, hosting, or managing applications comprising, for example, Artificial Intelligence (AI) agents which may be configured as supervisor agents, worker agents, or other types of AI-driven entities that orchestrate tasks, interpret intents, and generate responses, although the applications may be configured in other types and/or numbers of manners to perform other types and/or numbers of tasks in other examples.

The search platform 164 provides an environment for creating, configuring, deploying, hosting, or managing search applications. The search platform 164 is configured to perform information retrieval, knowledge discovery, and context gathering to support the execution of tasks by the applications. For example, a search application created using the search platform 164 may query structured or unstructured data sources, vector databases, relational databases, or external knowledge repositories to supply relevant information to the search application in real time.

The process platform 166 enables automation of enterprise processes by enabling developers to configure, monitor, and execute process applications. The process platform 166 supports triggers, workflows, and human-in-the-loop mechanisms for reviews and approvals. Additionally, the process platform 166 provides process monitoring tools and pre-built process templates to streamline workflow deployment, ensuring compliance, consistency, contextual decision-making, and actionable insights across diverse AI models, applications, or cloud environments.

The applications created using the automation platform 160 may comprise automation agents, agentic applications, non-agentic applications, search applications, or process applications, although other types and/or numbers of applications may be created in other examples. The applications may comprise deterministic and non-deterministic workflows, although other types and/or numbers of workflows may be created in other examples. The deterministic workflows may comprise sequences of tasks or workflows that execute in a fixed order based on user inputs and system rules, while non-deterministic workflows may enable dynamic task planning, adaptive decision-making, or agentic behavior that evolves based on contextual data, learned patterns, or real-time environmental factors.

FIG. 2B is a block diagram of the exemplary agent platform 162 of the automation server 150. The agent platform 162 comprises a plurality of automation agents 210(1)-210(n), a plurality of AI agents 250(1)-250(n), an agentic pattern manager 254, a model manager 260, a prompt manager 262, a data manager 264, an external model connector 266, although the agent platform 162 comprises other types and/or numbers of components in other configurations. The agent platform 162 provides capabilities for multi-agent orchestration and collaboration, including supervisor and worker models, agent memory management (both long-term and short-term), and inter-agent communication protocols (e.g., agent-to-agent or A2A protocols), although the agent platform 162 may provide other types and/or numbers of capabilities in other examples. The agent platform 162 further provides AI engineering tools such as a prompt studio, evaluation studio, model hub, model customization and optimization tools, although the agent platform 162 may provide other types and/or numbers of tools in other examples. Additionally, the agent platform 162 may provide observability and safety capabilities comprising agent tracing, insights, analytics, event monitoring, compliance tracking, and governance features such as guardrails, role-based access control (RBAC), versioning, audit logs, or enterprise-grade security.

The automation server 150 hosts and/or manages a plurality of automation agents 210(1)-210(n), each configured to provide an interactive interface through which users at the user devices 110(1)-110(n) may submit one or more user inputs and initiate automation tasks. Each of the automation agents 210(1)-210(n) may include one or more configurable automation workflows that define sequences of actions, decisions, or task executions. These workflows may be deterministic, following predefined paths, or dynamic, adapting to user context or agent reasoning. The automation agents 210(1)-210(n) may further enable developers or administrators to design, configure, and deploy one or more workflows.

The AI agents 250(1)-250(n) are autonomous software entities configured to perceive one or more inputs received from the computing environment 100, process the one or more inputs using reasoning, machine learning, or rule-based algorithms, and perform actions to achieve defined objectives, although the AI agents 250(1)-250(n) may process the inputs using other types and/or numbers of methods in other examples. In one example, the agent platform 162 enables the creation, configuration, deployment, management, or orchestration of the AI agents 250(1)-250(n), although the AI agents 250(1)-250(n) may be configured using other types and/or numbers of platforms in other examples. Each of the AI agents 250(1)-250(n) may operate independently or collaboratively, communicate with other ones of the AI agents 250(1)-250(n), the external AI agents 170(1)-170(n), or external systems, or adapt behavior over time through learning from outcomes and feedback.

The AI agents 250(1)-250(n) may be configured as part of one or more deterministic workflows or one or more dynamic workflows corresponding to one or more user intents configured for the automation agents 210(1)-210(n). The AI agents 250(1)-250(n) may be configured using one or more of the agentic patterns 254(1)-254(n) or one or more of the language models 260(1)-260(n).

The agentic pattern manager 254 enables configuring the AI agents 250(1)-250(n) with one or more of the agentic patterns 254(1)-254(n) to execute complex tasks, although the agentic pattern manager 254 enables other types and/or methods of configuring the agentic patterns 254(1)-254(n). These agentic patterns 254(1)-254(n) may include structured frameworks which, for example, combine reasoning and action loops to enable agents to iteratively plan, execute, and refine their behavior. By applying the agentic patterns 254(1)-254(n), the agentic pattern manager 254 enables the automation agents 210(1)-210(n) to be configured, instantiated, or modified without requiring low-level programming of each individual AI agent. In one example, the developer selects or generates one of the one or more agentic pattern 254(1)-254(n), binds the pattern to the AI agents 250(1)-250(n), and orchestrates the execution flow according to the pattern's rules, enabling the AI agents 250(1)-250(n) to handle multi-step tasks, dynamic decision-making, and interactive reasoning workflows.

The model manager 260 enables developers at the developer devices 130(1)-130(n) to customize, fine-tune, deploy, and monitor a plurality of language models 260(1)-260(n) such as, for example, large language models (LLMs), small language models, or fine-tuned models, or multimodal models across various artificial intelligence agents (hereinafter referred to as AI agents) or virtual assistants, although the model manager 260 may manage other types and/or numbers of language models in other examples. The model manager 260 supports loading, versioning, updating, and fine-tuning the language models 260(1)-260(n) in design time or real time, although the model manager 260 supports other types and/or numbers of functions in other examples.

The prompt manager 262 enables developers to craft, store, and iterate on prompts for the AI agents 250(1)-250(n) or the language models 260(1)-260(n) for multiple use cases although the prompt manager 262 may enable other types and/or numbers of functions in other examples.

The data manager 264 is configured to manage the ingestion, storage, retrieval, and preprocessing of both structured and unstructured data utilized by the automation platform 160. The data manager 264 further enables the storage and organization of data sets for purposes including, but not limited to, testing prompts, evaluating agent performance, or fine-tuning the language models 260(1)-260(n). In other examples, the data manager 264 may store additional types and/or quantities of data, supporting other types and/or numbers of operations of the automation platform 160.

The external model connector 266 is configured to facilitate interaction between the automation platform 160 and external computational models, services, or data sources. This component allows agents to leverage third-party models, cloud-based AI services, and other external systems for enhanced reasoning, analysis, or action execution.

FIG. 2C is a block diagram of an exemplary automation agent 210(1) of the automation server 150 comprising an orchestration agent 215, a workflow manager 230, a task decomposer 240, a task planner 242, a messager 244, a memory manager 246, and an agent configuration 252. When the user at, for example, the user device 110(1) initiates a conversation with the automation server 150 via the automation agent 210(1), the user device 110(1) provides the user input to the automation agent 210(1). The task decomposer 240 of the automation agent 210(1) receives a user input and decomposes the user input into one or more tasks, for example, comprising one or more intents or one or more sub-intents. If the user input cannot be decomposed, the task decomposer 240 provides an intent or a sub-intent based on the user input. In one example, one or more of the AI agents 250(1)-250(n) may be used by the task decomposer 240 to decompose user inputs.

The orchestration agent 215 may be configured with one or more of the AI agents 250(1)-250(n), which in turn may be implemented using one or more of the agentic patterns 254(1)-254(n) and/or one or more of the language models 260(1)-260(n). The orchestration agent 215 or the AI agents 250(1)-250(n) may be configured to perform dialog orchestration, routing decisions, reasoning, task decomposition, dynamic planning, context management, memory retrieval, response generation, summarization, collaboration with other ones of the plurality of AI agents 250(1)-250(n) or the external AI agents 170(1)-170(n), tool invocation, or adaptive decision-making based on real-time inputs or system events, although the orchestration agent 215 may be configured to perform other types and/or numbers of functions or tasks in other examples. In some examples, the orchestration agent 215 may evaluate task dependencies, prioritize execution order, and allocate subtasks to specialized AI agents based on capability, confidence score, or workload distribution. The orchestration agent 215 may further monitor progress, handle exceptions, and perform corrective actions or replanning when unexpected conditions occur.

The orchestration agent 215 of the agent platform 162 may route a user input received, for example, as part of a dialog session with the user at the user device 110(1) to the one or more deterministic workflows or the one or more dynamic workflows. The routing may be rule based or dynamically determined based on factors such as: a description of the AI agents 250(1)-250(n) or the external AI agents 170(1)-170(n), capabilities of the AI agents 250(1)-250(n) or the external AI agents 170(1)-170(n), metadata, agent card data of the AI agents 250(1)-250(n) or the external AI agents 170(1)-170(n), user intent determined from one or more user inputs, user data, a communication channel of the dialog session (voice, text, or the like), user type (gold, silver, platinum, or the like), historical success rate or failure rate, historical rate of containing a conversation or a part of a conversation within the one or more deterministic workflows or the one or more dynamic workflows, estimated cost of providing a response to the user input, or historical cost of providing a response to the user input, although the routing may be based on other types and/or numbers of factors in other examples.

The orchestration agent 215 receives user inputs from one or more of the user devices 110(1)-110(n) or one or more components of the automation platform 160 and provides outputs to the one or more of the user devices 110(1)-110(n) or the one or more components of the automation platform 160. In one example, the orchestration agent 215 may receive a component output from the task planner 242 to communicate with the deterministic workflow 220(1). The component output may comprise a task plan, although there may be other types of data in other examples.

The workflow manager 230 comprises code or configuration corresponding to one or more deterministic workflows 220(1)-220(n) or one or more dynamic workflows 222(1)-222(n) associated with the automation agent 210(1), the association between two or more nodes of the deterministic workflows 220(1)-220(n) or the dynamic workflows 222(1)-222(n), node names, prompt information, few shot examples, hyperparameters, or data corresponding to the one or more of the language models 260(1)-260(n) or the one or more of the agentic patterns 254(1)-254(n) associated with the automation agent 210(1).

The deterministic workflows 220(1)-220(n) follow a fixed, predefined path based on the nodes and their connections. In one example, the deterministic workflows 220(1)-220(n) may comprise a predefined chain of the AI agents 250(1)-250(n) that are communicatively coupled in a sequential orchestration pattern to execute tasks or decisions in a fixed order. In another example, the deterministic workflows 220(1)-220(n) may not comprise any of the AI agents 250(1)-250(n), the external AI agents 170(1)-170(n), or other AI agents, and may comprise a workflow defined as a sequence of interconnected nodes executed in a predefined order to fulfill a user intent. Each node in the deterministic workflow represents a specific step in the interaction and may handle functions such as collecting user inputs, invoking a service, or generating a response. Additional details of the deterministic workflow not comprising any of the AI agents 250(1)-250(n), the external AI agents 170(1)-170(n), or other AI agents and comprising a workflow defined as a sequence of interconnected nodes executed in a predefined order to fulfill a user intent are provided in U.S. Pat. No. 12,135,945, filed on Nov. 30, 2021, entitled “Systems and methods for natural language processing using a plurality of natural language models,” the content of which is incorporated herein by reference.

The dynamic workflows 222(1)-222(n) are configured as adaptive, non-deterministic workflows that enable dynamic orchestration and collaboration of one or more of the AI agents 250(1)-250(n) to accomplish, for example, complex, multi-step tasks. The dynamic workflows 222(1)-222(n) adjust their execution paths in real time based on factors such as user input, intermediate outputs, environmental variables, task descriptions, prompts, goals, or reasoning outcomes generated by one or more of the AI agents 250(1)-250(n) that are configured as components of the dynamic workflows 222(1)-222(n), although the execution may be modified or adjusted based on other types and/or numbers of factors in other examples.

In one example, users may provide one or more user inputs through a user interface of an automation agent 210(1) hosted and/or managed by the automation server 150. The user interface may be presented via a web application, mobile application, or other client interface configured to enable interactive communication with the automation agent 210(1). When the agent platform 162 determines the user intent (e.g. book flight) corresponding to a user input (e.g., “I want to book a flight”), the agent platform 162 triggers the corresponding one of the deterministic workflows 220(1)-220(n) or the dynamic workflows 222(1)-222(n).

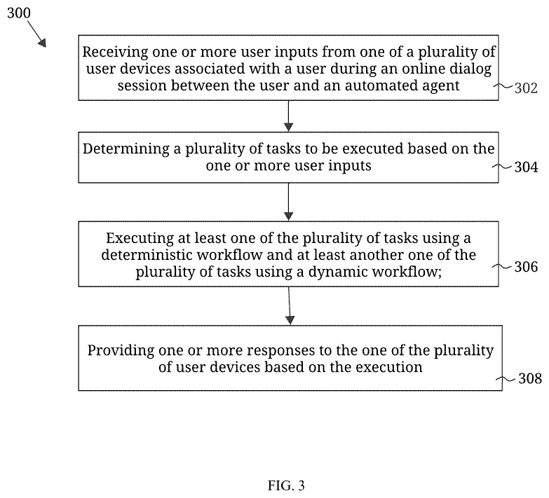

The agent platform 162 may host and/or manage the deterministic workflows 220(1)-220(n) or the dynamic workflows 222(1)-222(n) which are described and illustrated below with reference to examples shown in FIG. 2C-2F, and FIG. 3-5.

The task planner 242 receives the one or more tasks determined by the task decomposer 240 and determines a task plan of the received one or more tasks. Each task plan may define an execution strategy specifying whether a plurality of tasks in the task plan are to be executed in a serial sequence, in parallel, or through a hybrid combination thereof. For instance, tasks that are interdependent or require intermediate outputs may be scheduled for serial execution, whereas independent tasks may be executed in parallel to optimize performance and reduce latency. In another example, the task planner 242 determines task 1, task 2, and task 3, and generates a task plan where task 1 and task 2 are executed concurrently, followed by the execution of task 3 after the completion of both task 1 and task 2. The task planner 242 may evaluate factors such as task priority, resource availability, execution complexity, or dependency graphs to generate one or more task plans, although the one or more task plans may be determined based on other types and/or numbers of factors in other examples.

The messager 244 reasons through information available from ongoing conversations with the user devices 110(1)-110(n), enterprise documentation, or enterprise data and takes actions such as asking follow-up questions or suggesting potential solutions. In one example, while waiting for external data, the messager 244 of the automation agent 210(1) may engage the user with clarifying questions or partial solutions. The messager 244 may also summarize, rephrase, or generate responses to be provided to the user devices 110(1)-110(n), although other types and/or numbers of tasks may be performed in other examples.

In some examples, although the orchestration agent 215, the task decomposer 240, the task planner 242, and the messager 244 are illustrated as separate components for clarity of explanation, their respective functions may be combined or distributed differently. For example, the orchestration agent 215 may perform the functions of the task decomposer 240, or the functions of the task decomposer 240, the task planner 242, and the messager 244 may all be executed by the orchestration agent 215 or another single integrated component.

The memory manager 246 enables the automation server 150 to retain context from past interactions. The memory manager 246 may store, summarize, embed, index, or enhance one or more ongoing conversations, one or more previous conversations with one or more of the user devices 110(1)-110(n), although other types and/or numbers of tasks may be performed in other examples.

The agent configuration 252 may further comprise, for example, the automation agent 210(1) role, behavior, and personality, including tone and communication style, the databases to which the workflows of the automation agent 210(1) has access to, the API's that the workflows of the automation agent 210(1) can communicate with, or configuration data, although the agent configuration 252 may comprise other types and/or numbers of data in other examples.

FIG. 2D is a block diagram of an exemplary dynamic workflow 222(1) of the automation agent 210(1). The dynamic workflow 222(1) comprises an orchestration agent 215(1), a task decomposer 240(1), a task planner 242(1), a messager 244(1), a memory manager 246(1). In one example, the orchestration agent 215(1), a task decomposer 240(1), a task planner 242(1), a messager 244(1), a memory manager 246(1) are configured to perform tasks similar to the orchestration agent 215, the task decomposer 240, the task planner 242, the messager 244, and the memory manager 246 respectively, although other types and/or numbers of tasks may be performed in other examples.

FIG. 2E is an exemplary wireframe of a dynamic workflow 222(1) rendered in an agent builder graphical user interface provided by the automation server 150. The agent builder graphical user interface may be rendered in any of the developer devices 130(1)-130(n). The exemplary wireframe includes a left pane comprising a list of nodes provided by the automation server 150 to create the dynamic workflow 222(1). The exemplary wireframe includes a right pane comprising the dynamic workflow 222(1) including multiple nodes interconnected with each other. In one example, one or more developers at the developer devices 130(1)-130(n) may select the nodes from the left pane, place the selected nodes in the right pane and interconnect the placed nodes, for example, as illustrated in FIG. 3. In another example, the one or more developers at the developer devices 130(1)-130(n) may select or define associations for each node of the dynamic workflow 222(1). Based on the illustration in FIG. 3, for example, the orchestration agent 215(1) is associated with worker(1)-worker(10). Each of the worker(1)-worker(10) nodes may comprise at least one of the AI agents 250(1)-250(n).

The orchestration agent 215(1) oversees task execution by allocating tasks to the worker nodes, monitoring progress, and dynamically adjusting workflow execution based on predefined goals, execution time goals or real-time feedback. The worker node operates as the execution unit, carrying out specific actions or tasks as assigned by the supervisor, leveraging decision-making algorithms and learned behaviors. The tool node provides the functional capabilities or resources required by the worker, such as APIs, software libraries, or external systems, facilitating the execution of tasks and enabling complex interactions within the automation platform 160.

By way of example, a user operating the user device 110(1) may provide a user input such as, “Why is my laptop not charging, and what's the status of my repair ticket?” The automation agent 210(1) provides the user input to the orchestration agent 215, which, determines two tasks and provides the two tasks to the dynamic workflow 222(1). The two tasks may be—diagnosing a technical charging issue and retrieving repair ticket information. In one example, the orchestration agent 215 provides the user input to the dynamic workflow 222(1) and the orchestration agent 215(1) may use the task decomposer 240(1) and the task planner 242(1) to determine the plurality of tasks and a task plan to execute the plurality of tasks. The orchestration agent 215(1) may determine that the two tasks can be processed in parallel and initiate their execution through corresponding worker nodes within the dynamic workflow 222(1). While worker(7) accesses a domain-specific diagnostic model to analyze the charging issue, another worker(9) retrieves the repair ticket data from an enterprise database. Simultaneously, worker(5) may interact with the user in real-time via the orchestration agent 215(1) by asking providing questions such as, “Have you tried using a different power adapter?” Based on the responses and collected data, worker(1) evaluates multiple decision paths—such as suggesting a replacement adapter or escalating the issue to a support agent—and selects the optimal course of action. Upon completion, worker(6) analyzes the interaction outcomes to refine future reasoning steps. The orchestration agent 215(1) use or synthesize the outputs from the worker(5), the worker(7), the worker(9) and generates one or more responses for presentation to the user device 110(1), although the orchestration agent 215(1) may use or synthesize outputs from other types and/or numbers of worker nodes of the dynamic workflow 222(1) or other components of the automation agent 210(1) in other examples.

FIG. 2F is an exemplary wireframe of a deterministic workflow 220(1) rendered in an agent builder graphical user interface provided by the automation server 150. The exemplary wireframe includes a left pane comprising a list of nodes provided by the automation server 150 to create the deterministic workflow 220(1). The exemplary wireframe includes a right pane comprising the deterministic workflow 220(1) including multiple nodes interconnected with each other. In one example, one or more developers at the developer devices 130(1)-130(n) may select the nodes from the left pane, place the selected nodes in the right pane and interconnect the placed nodes, for example, as illustrated in FIG. 3. In another example, the one or more developers at the developer devices 130(1)-130(n) may select associations for each node of the deterministic workflow 220(1). Based on the illustration in FIG. 3, for example, worker(1)-worker(10) are connected with each other in a sequence. Each of the worker(1)-worker(10) nodes may be configured with at least one of the AI agents 250(1)-250(n). The worker(1)-worker(10) may dynamically transfer control and context of a task in the sequence without requiring orchestration. Although not illustrated, in some examples, the deterministic workflow 220(1) comprises a task decomposer 240(2), a task planner 242(2), a messager 244(2), and a memory manager 246(2), although the deterministic workflow 220(1) may comprise other types and/or numbers of components in other examples.

FIG. 3 is a flowchart of an exemplary method 300 for orchestrating an online interaction with a user at one of the user devices 110(1)-110(n). For example, the method 300 can be implemented using the computing environment 100, such as described above in reference to FIGS. 1, 2A-2D. As one example, computer-executable instructions for carrying out the method 300 can be stored in computer-readable memory (e.g., the memory 154) and the instructions can be executed by the processor 152 to perform the method 300. The automation server 150 receives communication from the user devices 110(1)-110(n) via an interface of an automation agent, for example, the automation agent 210(1) and provides responses to the communication. An enterprise user, such as a developer or a business analyst by way of example, may create or configure the automation agent using the tools and/or services provided by the automation server 150. In one example, when a user at, for example, the user device 110(1) communicates with the automation agent 210(1) hosted and/or managed by the automation server 150, the automation server 150 may provide a response to the user communication by communicating with the agent platform 162, the search platform 164, the process platform 166, or one or more other components of the computing environment 100, although the response may be provided by communicating with other types and/or numbers of components in other examples.

At step 302, the automation server 150 receives one or more user inputs from one of the user devices 110(1)-110(n), for example user device 110(1), associated with a user during an online dialog session between the user and an automation agent 210(1) hosted and/or managed by the automation server 150. The dialog session may be initiated by the user or automatically triggered by the automation platform 160 of the automation server 150 based on a scheduled task, notification, or event, although the dialog session may be initiated based on other types and/or numbers of triggers or events. In another example, the automation server 150 may transmit an initial greeting message or prompt to the user device 110(1) to establish the conversation context and invite user interaction. The one or more user inputs may include natural language inputs, typed text, voice commands, or other forms of multimodal input (e.g., selections, clicks, or gestures). The orchestration agent 210 of the automation server 150 provides the received one or more user inputs to the task decomposer 240.

At step 304, the task decomposer 240 of the automation server 150 determines a plurality of tasks to be executed based on the one or more user inputs. The task decomposer 240 analyzes the one or more user inputs received by the automation server 150 to determine the tasks. The tasks determined may comprise a plurality of executable actions that collectively fulfill the one or more user inputs. In one example, the tasks determined comprise one or more intents. The determination of the tasks may be performed using the language models 260(1)-260(n) or machine learning models associated with the task decomposer 240, although other types and/or numbers of methods may be used to interpret the one or more user inputs.

Subsequent to the task decomposer 240 determining the tasks, the task decomposer 240 provides the tasks to the task planner 242 which determines a task plan. Subsequently, the task planner 242 provides the task plan to the orchestration agent 215. The orchestration agent 215 determines the deterministic workflows 220(1)-220(n) or the dynamic workflows 222(1)-222(n) to route the tasks to, based on the task plan. Subsequently, the orchestration agent 215 routes each task to the corresponding workflow for execution based on the task plan. The orchestration agent 215 may dynamically manage the dialog session by routing each task to either one or more of the deterministic workflows 220(1)-220(n) or one or more of the dynamic workflows 222(1)-222(n). The routing of the tasks may be based on the one or more intents of the tasks. For example, when the determined task corresponds to a user intent such as “process refund,” the orchestration agent 210 may communicate with and provide instructions to a workflow associated with refund processing, comprising a sequence of AI agents and actions designed to validate user identity, retrieve transaction data, and execute the refund.

At step 306, the automation server 150 executes at least one of the tasks using one of the deterministic workflows 220(1)-220(n) and at least another one of the tasks using one of the dynamic workflows 222(1)-222(n). The workflows execute the one or more of the tasks routed to them, performing actions necessary to complete the one or more of the tasks, which may include fulfilling one or more detected intents or one or more sub-intents corresponding to the tasks, executing one or more tools, performing a search or retrieval operation to obtain information relevant to the one or more user inputs, or transferring the task to a human agent for resolution, data generation, manipulation, interactions with: one or more of the user devices 110(1)-110(n), one or more of the AI agents 250(1)-250(n), databases, application programming interfaces, other software systems, or human agents, although the workflows may perform other types and/or numbers of actions in other examples.

For example, when the user input is—“Please update my shipping address and verify that all my pending orders are being shipped to the new address”—is received from the user device 110(1), the task decomposer 240 analyzes the user input and determines two tasks to be executed. The first task, corresponding to an intent—update shipping address, is a database update operation that may be executed by, for example, the deterministic workflow 220(1). The second task, corresponding to another intent—verifying that all pending orders reflect the updated address, is a multi-step process involving the retrieval of active order records, validation of shipping data across multiple systems, and generation of a confirmation response for the user, may be executed by the dynamic workflow 222(1).

In one example, the tasks may be executed according to the determined task plan, enabling efficient orchestration of multi-step workflows within the automation platform 160. For example, the task plan may comprise that the first task and the second task may be executed in parallel. Accordingly, the automation server 150 may execute the first task and the second task in parallel.

At step 308, the automation server 150 provides one or more responses to the one of the user devices 110(1)-110(n) based on the execution. Subsequent to the execution, the deterministic workflow 220(1) may provide a first output to the orchestration agent 215, and the dynamic workflow 222(1) may provide a second output to the orchestration agent 215. In one example, the orchestration agent 215 may provide the first output and the second output as the one or more responses to the one of the user devices 110(1)-110(n). In another example, the orchestration agent 215 may provide the first output and the second output to the messager 244 to generate a response. The orchestration agent 215 may receive the response generated by the messager 244 and provide the response to the one of the user devices 110(1)-110(n). In another example, the deterministic workflow 220(1) and the dynamic workflow 222(1) may provide the one or more responses directly to the one of the user devices 110(1)-110(n).

The execution of tasks using the deterministic workflows 220(1)-220(n) and the dynamic workflows 222(1)-222(n) enables efficient management of complex dialog interactions. Such execution improves the overall response time to user inputs, reduces processor utilization and computational overhead, enhances the accuracy and contextual relevance of generated responses, and provides greater flexibility for developers to select or dynamically combine the deterministic workflows 220(1)-220(n) and the dynamic workflows 222(1)-222(n) for optimal performance. In addition, the examples described facilitate adaptive scaling across multiple agents or workflows, improves system throughput under varying workloads, and enables more efficient utilization of workflow-specific strengths depending on the detected task or user intent.

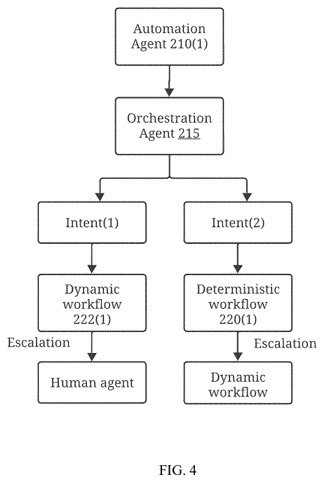

FIG. 4 is a block diagram of an exemplary automation agent 210(1) configured using the automation platform 160. In this example, the orchestration agent 215 routes the user inputs provided to the automation agent 210(1) to the deterministic workflow 220(1) or the dynamic workflow 222(1). In this example, the orchestration agent 215 routes all user inputs corresponding to intent(1) to the dynamic workflow 222(1) and all user inputs corresponding to intent(2) to the deterministic workflow 220(1). Escalation conditions may be configured for the deterministic workflow 220(1) or the dynamic workflow 222(1). For example, upon detecting an escalation condition during the execution of the deterministic workflow 220(1), the subsequent user inputs in the conversation may be routed to the dynamic workflow 222(1) for execution. Similarly, upon detecting an escalation condition during the execution of the dynamic workflow 222(1), the subsequent user inputs in the conversation may be routed to a human agent. It may be understood that other such escalation conditions may be configured or determined dynamically based on the dialog session by the automation server 150 in other examples.

The escalation conditions may include, for example, an escalation intent in the user inputs, receiving a threshold number of inputs (e.g., two consecutive inputs, or two out of the last three inputs) from the user at one of the user devices 110(1)-110(n) with a same intent, detecting a negative sentiment in the user inputs, an account type of the user, a user preference in the user input to communicate with a human agent, the user input comprising negative words or phrases (e.g., wrong, incorrect, not correct, false, or the like), the automation server 150 unable to identify an intent from the user inputs, frequency of inputs from the user devices 110(1)-110(n) is greater than a threshold, a recent input from the user device 110(n) is a repeat of an earlier input received from the user device 110(n) during the dialog session, the dialog session continuing for a threshold amount of time (e.g., three minutes, five minutes, or the like), a number of error responses output by the automation server 150 to the user at one of the user devices 110(1)-110(n) is greater than a threshold, although other types and/or numbers of escalation conditions may be defined in other configurations. In one example, the developers at the developer devices 130(1)-130(n) may define one or more escalation conditions when the automation agents 210(1)-210(n) is being configured and store them as part of the agent configuration, for example, agent configuration 252. In another example, the automation server 150 may determine one or more escalation conditions during run-time based on the dialog session between the user at one of the user devices 110(1)-110(n) and the automation server 150.

The orchestration agent 215 may route the conversation from the deterministic workflows 220(1)-220(n) or the dynamic workflows 222(1)-222(n) to a human agent at the human agent devices 140(1)-140(n). In one example, the orchestration agent 215 or the deterministic workflows 220(1)-220(n) or the dynamic workflows 222(1)-222(n) may be configured or trained to determine an escalation condition and route the conversation to the human agent devices 140(1)-140(n).

In another example, orchestration agent 215 or the AI agents 250(1)-250(n) may continuously monitor a conversation between a human agent, for example, at the human agent device 140(1) and a user, for example, at the user device 110(1), and based on the monitoring provide resources to assist the human agent in providing responses to the user device 110(1). The automation agent 210(1) may, for example, contextually pop-up in the agent desktop GUI of the human agent device 140(1) to provide assistance when required.

Additionally, the orchestration agent 215 may offer one or more options in the agent desktop GUI of the human agent device 140(1) during the dialog session to route the conversation to the deterministic workflows 220(1)-220(n) or the dynamic workflows 222(1)-222(n). Upon the human agent selecting the one or more options, the orchestration agent 215 may route the conversation to the deterministic workflows 220(1)-220(n) or the dynamic workflows 222(1)-222(n). Once a goal of the routing is either fulfilled, or not fulfilled or partially fulfilled, the orchestration agent 215 gives the control of the conversation back to the human agent, and provides a summary of the conversation handled by the deterministic workflows 220(1)-220(n) or the dynamic workflows 222(1)-222(n) to the human agent.

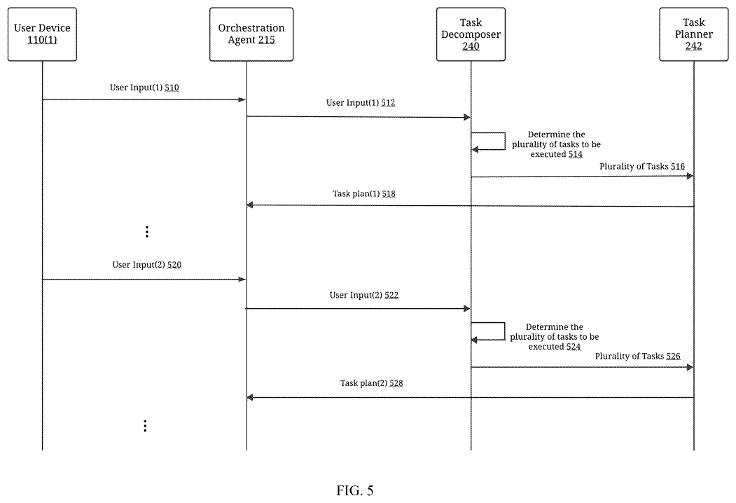

FIG. 5 is a diagram of an exemplary interaction flow between different components of the computing environment 100. The user at the user device 110(1) initiates a dialog session with, for example, an automation agent 210(1) of the automation server 150.

As part of the dialog session, at step 510, the user device 110(1) provides a user input(1) to the automation agent 210(1) which is routed to the orchestration agent 215.

At step 512, the orchestration agent 215 provides the user input(1) to the task decomposer 240.

At step 514, the task decomposer 240 interprets or analyzes the user input(1) and determines a plurality of tasks to be executed to fulfill the user input(1). In one example, the tasks comprise one or more intents, for example, resolve login issue, check refund status, or the like.

At step 516, the task decomposer 240 provides the tasks to the task planner 242. The task planner 242 determines an order of execution of the tasks.

At step 518, the task planner 242 provides a task plan(1) to the orchestration agent 215. The task plan(1) may comprise for the one or more tasks: an order of execution of the tasks, text or instructions to be provided to any of the deterministic workflows 220(1)-220(n) or the dynamic workflows 222(1)-222(n), although the task plan(1) may comprise other types and/or numbers of data in other examples. Subsequently, the nodes of one or more of the deterministic workflows 220(1)-220(n), one or more of the dynamic workflows 222(1)-222(n), or other components of the computing environment 100 communicate and work together to provide a response(1) to the user input(1).

Continuing the conversation, at step 520, the user device 110(1) provides input(2) to the automation agent 210(1) which is routed to the orchestration agent 215.

At step 522, the orchestration agent 215 provides the user input(2) to the task decomposer 240.

At step 524, the task decomposer 240 analyzes the user input(2) and determines a plurality of tasks to be executed.

At step 526, the task decomposer 240 provides the tasks to the task planner 242. The task planner 242 determines an order of execution of the tasks. It may be understood that when the task decomposer 240 determines only one task, the task planner 242 may not determine an order of execution.

At step 528, the task planner 242 provides a task plan(2) to the orchestration agent 215. The task plan(2) may comprise for the tasks: an order of execution of the tasks, text or instructions to be provided to any of the deterministic workflows 220(1)-220(n) or the dynamic workflows 222(1)-222(n), although the task plan(2) may comprise other types and/or numbers of data in other examples. Subsequently, the nodes of one or more of the deterministic workflows 220(1)-220(n), one or more of the dynamic workflows 222(1)-222(n), or other components of the computing environment 100 communicate and work together to provide a response(2) to the user input(2). In this manner, the user at the user device 110(1) may continue the conversation with the automation agent 210(1) of the automation server 150.

In one example, the nodes of the deterministic workflows 220(1)-220(n) or the dynamic workflows 222(1)-222(n) may be configured with one or more of the agentic patterns 254(1)-254(n) capable of: exploring multiple paths of the flow and simulating potential outcomes before choosing an optimal action, learning from past conversations with the user devices 110(1)-110(n), routing tasks to specialized sub-systems or models that are domain experts (e.g. finance, technical support, or the like), handling multimodal input such as text, image, audio, or video.

Various exemplary user inputs and the response generation methods of the automation server 150 to the one or more user inputs are described below. In one example, the user at the user device 110(1) provides the user input: “I need help accessing my account, and I want to check the status of my refund.” The user input is provided to the task decomposer 240 which decomposes the user input into the tasks: accessing the account (login issue) and checking the refund status. The tasks are provided to, for example, the dynamic workflow 222(1) and the deterministic workflow 220(1) which execute the tasks in parallel. While the deterministic flow 220(1) is being executed, the dynamic workflow 222(1) uses conversation history and fetched user account data, and if the user account data indicates a locked account, the dynamic workflow 222(1) may provide an output to the orchestration agent 215—“It looks like your account might be locked. Would you like to reset your password.” As the orchestration agent 215 maintains the contextual understanding that the refund status is being checked, the orchestration agent 215 generates the response “It looks like your account might be locked. Would you like to reset your password while I check your refund status?” In one example, the orchestration agent 215 may provide the output received from the dynamic workflow 222(1) and the contextual understanding as inputs to the messager 244 to generate the response. In this manner, the automation agent 210(1) keeps the user engaged while fetching the refund status. Once the refund status is fetched, the deterministic workflow 220(1) can based on the fetched information provide the output, for example, “your refund is still being processed. It should be completed within 2-3 days.” The orchestration agent 215 may provide the output of the deterministic workflow 220(1) as another response to user device 110(1).

In one example, the dynamic workflow 222(1) may comprise a worker(1) which is an AI agent 250(1) configured with, for example, an agentic pattern(3) that can explore multiple paths of the dynamic workflow 222(1) and simulate potential outcomes. The dynamic workflow 222(1) routes the execution to the worker(1) which may determine the paths to explore based on the one or more tasks determined by the task decomposer 240(1) corresponding to the dynamic workflow 222(1). In this example, the worker(1) determines the paths: Path 1: Offering troubleshooting steps to unlock the account, Path 2: Escalating the issue to human support if the refund is delayed. For each path, the worker(1) calculates the likelihood of success. For example: the worker(1) may predict that resetting the password will solve the login issue based on the current account status. The worker(1) might escalate the refund query if the system predicts further delay in processing. After evaluating the possible outcomes, the worker(1) selects the optimal course of action.

The worker(1) may transmit a proposed course of action to the orchestration agent 215(1). Based on the received course of action, the orchestration agent 215(1) may determine a corresponding task to be executed, such as the password reset task, and may route the task to another worker, for example worker(7), that is configured to perform the identified task. Upon execution, the worker(7) may generate and transmit a response to the orchestration agent 215(1), which in turn may communicate the response to the orchestration agent 215 and ultimately to the user device 110(1).

In one example, when the worker(1) does not solve the problem, the dynamic workflow 222(1) may route the conversation to worker(2) configured with, for example, an agentic pattern(4) configured to learn from past conversations with the user device 110(1). In one example, the worker(1) and worker(2) may interact with each other. The worker(2) learns from the failed action of worker(1) by self-reflection: analyzing what went wrong: Did the password reset fail due to incorrect inputs? Was there a delay in processing the refund beyond the expected time? and updates the reasoning to avoid making the same mistake in the future. For subsequent user inputs, the worker(1) and the worker(2) may work together and may suggest alternative troubleshooting steps or escalate the refund issue more quickly based on prior experiences. Also, each of the orchestration agent 215(1) or the worker nodes of the dynamic workflow 222(1) may learn continuously at run-time based on the outputs they provide and the inputs they receive.

In one example, a worker(3) of the dynamic workflow 222(1) is configured with an agentic pattern(6) configured to route queries to specialized sub-systems based on the type of user input. If the query is about financial issues (e.g., refunds, payments), the worker(3) routes to the conversation to a node specialized in handling financial queries. For technical issues (e.g., account login problems), the worker(3) routes the conversation to a node configured with a specialized technical support model.

In one example, worker(4) of the dynamic workflow 222(1) is configured with an agentic pattern(7) configured to manage or handle multimodal input. The worker(4), for example, can analyze a screenshot for a specific error code and suggest appropriate troubleshooting steps. If the user sends a voice note, the worker(4), for example, can transcribe voice note and use the text to continue the conversation.

At the end of this multi-pattern workflow, the automation agent 210(1): provides a solution, escalates appropriately if needed, and also learns and improves. By combining these agentic patterns and models, a modular and an extensible framework may be created.

Having thus described the basic concept of the invention, it will be rather apparent to those skilled in the art that the foregoing detailed disclosure is intended to be presented by way of example only, and is not limiting. Various alterations, improvements, and modifications will occur and are intended for those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method comprising:
receiving, by an automation server, one or more user inputs from one of a plurality of user devices associated with a user during an online dialog session between the user and an automation agent;
determining, by the automation server, a plurality of tasks to be executed based on the one or more user inputs;
executing, by the automation server, at least one of the plurality of tasks using a deterministic workflow and at least another one of the plurality of tasks using a dynamic workflow; and
providing, by the automation server, one or more responses to the one of the plurality of user devices based on the execution.

2. The method of claim 1, wherein the plurality of tasks comprise execution of: one or more intents, one or more sub-intents, a transfer to a human agent, or a search task.

3. The method of claim 1, further comprising determining one or more task plans for executing the plurality of tasks, wherein each of the one or more task plans specify serial or parallel execution of the plurality of tasks, and wherein the plurality of tasks are executed according to the determined one or more task plans.

4. The method of claim 1, wherein the deterministic workflow is executed by traversing a predefined sequence of nodes.

5. The method of claim 1, wherein the deterministic workflow is associated with at least one user intent.

6. The method of claim 1, wherein the at least one of the plurality of tasks is executed using a dynamic workflow by automatically traversing one or more orchestration agents and one or more worker agents based on the one or more tasks.

7. The method of claim 1, wherein upon detecting an escalation condition, subsequent user inputs following the one or more user inputs are executed using a dynamic workflow.

8. An automation server comprising:
one or more processors; and
a memory coupled to the one or more processors which are configured to execute programmed instructions stored in the memory to:
receive one or more user inputs from one of a plurality of user devices associated with a user during an online dialog session between the user and an automation agent;
determine a plurality of tasks to be executed based on the one or more user inputs;
execute at least one of the plurality of tasks using a deterministic workflow and at least another one of the plurality of tasks using a dynamic workflow; and
provide one or more responses to the one of the plurality of user devices based on the execution.

9. The automation server of claim 8, wherein the plurality of tasks comprise execution of: one or more intents, one or more sub-intents, a transfer to a human agent, or a search task.

10. The automation server of claim 8, further comprising determining one or more task plans for executing the plurality of tasks, wherein each of the one or more task plans specify serial or parallel execution of the plurality of tasks, and wherein the plurality of tasks are executed according to the determined one or more task plans.

11. The automation server of claim 8, wherein the deterministic workflow is executed by traversing a predefined sequence of nodes.

12. The automation server of claim 8, wherein the deterministic workflow is associated with at least one user intent.

13. The automation server of claim 8, wherein the at least one of the plurality of tasks is executed using a dynamic workflow by automatically traversing one or more orchestration agents and one or more worker agents based on the one or more tasks.

14. The automation server of claim 8, wherein upon detecting an escalation condition, subsequent user inputs following the one or more user inputs are executed using a dynamic workflow.

15. A non-transitory computer-readable medium storing instructions which when executed by one or more processors, causes the one or more processors to:
receive one or more user inputs from one of a plurality of user devices associated with a user during an online dialog session between the user and an automation agent;
determine a plurality of tasks to be executed based on the one or more user inputs;
execute at least one of the plurality of tasks using a deterministic workflow and at least another one of the plurality of tasks using a dynamic workflow; and
provide one or more responses to the one of the plurality of user devices based on the execution.

16. The non-transitory computer-readable medium of claim 15, wherein the plurality of tasks comprise execution of: one or more intents, one or more sub-intents, a transfer to a human agent, or a search task.

17. The non-transitory computer-readable medium of claim 15, further comprising determining one or more task plans for executing the plurality of tasks, wherein each of the one or more task plans specify serial or parallel execution of the plurality of tasks, and wherein the plurality of tasks are executed according to the determined one or more task plans.

18. The non-transitory computer-readable medium of claim 15, wherein the deterministic workflow is executed by traversing a predefined sequence of nodes.

19. The non-transitory computer-readable medium of claim 15, wherein the deterministic workflow is associated with at least one user intent.

20. The non-transitory computer-readable medium of claim 15, wherein the at least one of the plurality of tasks is executed using a dynamic workflow by automatically traversing one or more orchestration agents and one or more worker agents based on the one or more tasks.

21. The non-transitory computer-readable medium of claim 15, wherein upon detecting an escalation condition, subsequent user inputs following the one or more user inputs are executed using a dynamic workflow.
